(19) United States
(12) Patent Application Publication
(10) Pub. No.: US 2025/0301011 A1
(43) Pub. Date: Sep. 25, 2025

(54) ARRANGEMENT AND A METHOD OF THREAT PREVENTION IN A COMPUTER OR COMPUTER NETWORK

(71) Applicant: WithSecure Corporation, HELSINKI (FI)

(72) Inventor: Jarno NIEMELÄ, Helsinki (FI)

(21) Appl. No.: 19/081,341

(22) Filed: Mar. 17, 2025

(30) Foreign Application Priority Data
Mar. 19, 2024 (GB) 2403893.7

(51) Int. Cl. H04L 9/40

(52) U.S. Cl. CPC H04L 63/1433; H04L 63/1425

(57) ABSTRACT

An arrangement (410) and a method, e.g. a computer implemented method, of threat prevention in a computer (101, 205a-205h) or computer network (201), wherein the method comprises collecting data related to the computer (101, 205a-205h) and/or computer network (201), the collected data relating at least to behavior of at least one application, building a model of normal behavior of the at least one application based on the collected data, requesting and/or receiving vulnerability information relating to the at least one application, building a configuration for the application, e.g. application control policy for the application, if the received vulnerability information indicates that the application has a vulnerability, wherein the built configuration restricts and/or prevents the operation of the application if a deviation is observed between the monitored behavior of the application and the built normal model of the application.

### TECHNICAL FIELD

The present invention relates to an arrangement and a method of threat prevention and/or threat detection in a computer or computer network.

### BACKGROUND

Security systems for computers and computer networks are used to detect threats and anomalies in computers and networks. Examples of such are Endpoint Detection & Response (EDR) and Managed Detection and Response (MDR) products and services. EDR focuses on the detection and monitoring of a breach as it occurs and helps to determine how best to respond to the detected breach. The growth of efficient and robust EDR solutions has been made possible in part by the emergence of machine learning, big data and cloud computing. MDR in turn is a managed cybersecurity service providing service for threat detection, response and remediation.

Modern EDR and MDR services can rely on endpoint-side software agents or sensors that collect, preprocess and submit relevant state and behavioral data to the backend side whose data processing pipelines focus on advanced enrichment and analysis of the data for further timely attack detection and response. Increasing complexity and sophistication of advanced cyberattacks requires continuous development and maintenance of mechanisms from EDR and MDR service providers to be able to provide early detection of new and modified attack patterns.

Security systems can also monitor vulnerabilities in computers, networks and software applications. These kind of security solutions can be called vulnerability management solutions. The goal of vulnerability management is to reduce the risk of security breaches and data compromises by proactively addressing weaknesses before they can be exploited by attackers. Vulnerability management solutions may continuously scan systems and networks for potential vulnerabilities. Vulnerabilities can arise e.g. from software bugs, misconfigurations, or outdated software versions. Once vulnerabilities are identified, they need to be assessed to determine their severity and potential impact on the organization's security posture. This assessment helps to prioritize which vulnerabilities should be addressed first. Vulnerability management solutions can prioritize vulnerabilities e.g. based on their severity, exploitability, and potential impact. Once vulnerabilities are identified and prioritized, organizations can take steps to mitigate or remediate them. This may involve applying software patches, reconfiguring systems, or implementing additional security controls to reduce the risk of exploitation.

A problem with vulnerability management is that on any sizeable organization it is impossible to patch all vulnerabilities, especially in time before attackers leverage some of them. One of the approaches to address this problem is to manually use application control, firewall and other isolation or limiting component configurations, e.g. by IT personnel, to make successful use of exploitation as difficult as possible. However, since this is manual work, it is also error prone and time consuming.

For these reasons there is a need for a reliable and efficient threat detection method, threat detection network and threat detection service which is also able to respond quickly to emerging threats and/or vulnerabilities.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

According to a first aspect, the invention relates to a method, e.g. a computer implemented method, of threat prevention in a computer or computer network, wherein the method comprises collecting data related to the computer and/or computer network, the collected data relating at least to behavior of at least one application, building a model of normal behavior of the at least one application based on the collected data, requesting and/or receiving vulnerability information relating to the at least one application, building a configuration for the application, e.g. an application control policy for the application, if the received vulnerability information indicates that the application has a vulnerability, wherein the built configuration restricts and/or prevents the operation of the application if a deviation is observed between the monitored behavior of the application and the built normal model of the application.

In one embodiment of the invention the built configuration restricts the operation of the application by only allowing essentially the behavior of the application corresponding the build model of the normal behavior of the application, and/or restricting and/or preventing essentially any other operation of the application.

In one embodiment of the invention the built configuration allows network connections, file write destinations, and/or child process executions based on the created model, e.g. so that similar kind of actions are allowed which have been previously done on said computer.

In one embodiment of the invention the built configuration comprises process execution, file write, network destination, firewall, sandbox, ApplicationControl, Applocker, Windows Sandbox, Microsoft Defender and/or Application Guard configurations.

In one embodiment of the invention an alert is created and/or sent for behavior of the application which is not allowed based on the model of the normal operation of the application.

In one embodiment of the invention if the application attempts to carry out tasks that are not allowed based on the model of the normal operation of the application, the application is allowed to run in a restricting environment, such as a sandbox.

In one embodiment of the invention the collected data from which the model of normal behavior of the application is built comprises expected and/or frequently occurred monitored behavior of the application.

In one embodiment of the invention the data is collected from the computer, computer network and/or at the backend system by at least one security agent module which collects data related to the computer and/or computer network, wherein the security agent module is e.g. a module of an EDR- and/or MDR-system, and/or wherein the data is collected at least in part from event telemetry flow.

In one embodiment of the invention the model of normal behavior is built for applications, e.g. essentially all applications of the computer, which run and/or execute at the computer longer than a predefined duration.

In one embodiment of the invention building the model of normal behavior of an application comprises collecting information relating to usage of the application, e.g. frequency of operations and/or types of operations related to the application.

In one embodiment of the invention the vulnerability information concerning an application is received from a server, a service, a backend system, and/or an external source.

According to a second aspect, the invention relates to an arrangement for threat prevention in a computer or computer network, wherein the arrangement comprises at least one computer, and the arrangement is configured to collect data related to the computer and/or computer network, the collected data relating at least to behavior of at least one application, to build a model of normal behavior of the at least one application based on the collected data, to request and/or receive vulnerability information relating to the at least one application, to build a configuration for the application, e.g. application control policy for the application, if the received vulnerability information indicates that the application has a vulnerability, wherein the built configuration is configured to restrict and/or prevent the operation of the application if a deviation is observed between the monitored behavior of the application and the built normal model of the application.

In one embodiment of the invention the arrangement is configured to carry out a method according to any embodiment of the invention.

According to a third aspect, the invention relates to a computer program comprising instructions which, when executed by a computer, cause the computer to carry out a method according to the invention.

According to a fourth aspect, the invention relates to a computer-readable medium comprising the computer program according to the invention.

With the solution of the invention, a model or a map of common behaviour for any application or service that is running on a monitored device, such as a computer or host, can be created and this information can be used to build automatic mitigation configurations which prevent the application from carrying out actions which may reduce security of the organization. This way any organization which utilizes the solution of the invention is able to be protected against emerging vulnerabilities efficiently before the vulnerabilities are patched. In one embodiment of the invention the restricting configurations are built only for the vulnerable applications which makes the solution efficient as the resources are directed only for applications with high risk. If an application configuration and/or application control policy would be created for every single application (even without vulnerabilities) that would use cause high resource usage, as e.g. policy checks are not computationally free, and also the number of false alarms could be massive when the hosts are carrying out any new actions or operations.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

The embodiments of the invention are illustrated by way of example, and not by way of limitation, in the figures of the accompanying drawings.

FIG. 1 presents as a schematic diagram a computer system or computer network configuration, for which exemplifying embodiments of the present invention are applicable.

FIG. 2 presents schematically an example network architecture of one embodiment of the invention.

FIG. 3 presents an example method according to one embodiment of the invention.

FIG. 4 presents as a schematic diagram an example structure of an arrangement according to an embodiment of the present invention.

### DETAILED DESCRIPTION

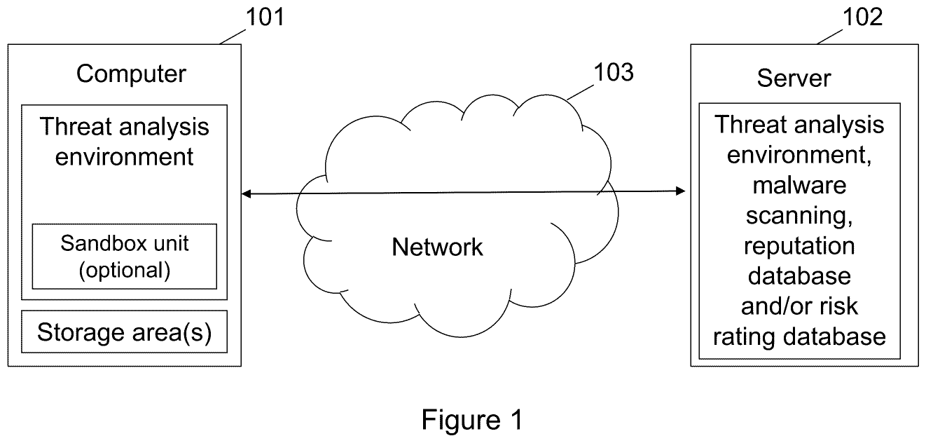

FIG. 1 presents an environment in which the solution of the invention can be used. In the solution of FIG. 1 a system configuration is presented in which a local computer 101 and a remote entity or server 102 are connected via a network 103. Here, the computer 101 exemplifies any host, computer or communication system, including a single device, a network node or a combination of devices, on which threat detection and/or prevention is to be performed. The threat prevention and/or detection can be done at the host and/or at the server. For example, the computer 101 may include a host, a personal computer, a personal communication device, a network-enabled device, a client, a firewall, a mail server, a proxy server, a database server, or the like. The server 102 exemplifies any computer or communication system, including a single device, a network node or a combination of devices, on which threat prevention and/or detection can be performed for the computer 101, or which can provide data for the computer 101 required to carry out the threat prevention and/or detection at the host, such as vulnerability info, risk rating and/or reputation data. For example, the server 102 may include a security entity or a backend entity of a security provider, or the like, and the server 102 may be realized in a cloud implementation or the like.

According to exemplifying embodiments of the invention, threat detection, threat prevention and/or malware detection at the computer 101 and/or by the server 102 can be realized using a threat analysis environment, such as a virtual machine or emulator environment, which can be arranged at the computer and/or at the server. For example, an agent or a sensor, such as e.g. an EDR/MDR-software agent and/or anti-virus software can be installed/arranged at the computer 101 to be used for threat detection, threat prevention, vulnerability and/or malware scanning. In one embodiment of the invention a sensor or agent at the computer is used to allow to intercept a file, a system configuration value and/or network operations called by the application. The sensor can be used to observe operation of the device, such as a computer, and information collected by the sensor can be used to detect malicious behavior of an application, a file and/or a process and/or a vulnerability related to an application.

The network 103 exemplifies any computer or communication network, including e.g. a (wired or wireless) local area network like LAN, WLAN, Ethernet, or the like, a (wired or wireless) wide area network like WiMAX, GSM, UMTS, LTE, or the like, and so on. Hence, the computer 101 and the server 102 can but do not need to be located at different locations. For example, the network 103 may be any kind of TCP/IP-based network. Communication between the computer 101 and the server 102 over the network 103 can be realized using for example any standard or proprietary protocol carried over TCP/IP, and in such protocol the malware scanning agent at the computer 101 and the malware analysis sandbox or application at the server 102 can be represented on/as the application layer.

A threat detection network according to one embodiment of the invention may comprise at least one node, such as a network node and/or a computer, and at least one backend server. In this case information, e.g. threat detection models and/or model of normal behavior of an application, can be shared between the nodes and/or between the nodes and the backend server. In one embodiment of the invention the threat detection network can comprise only a plurality of nodes and no backend server is necessary. In this case information, e.g. threat detection models, can be shared between the nodes.

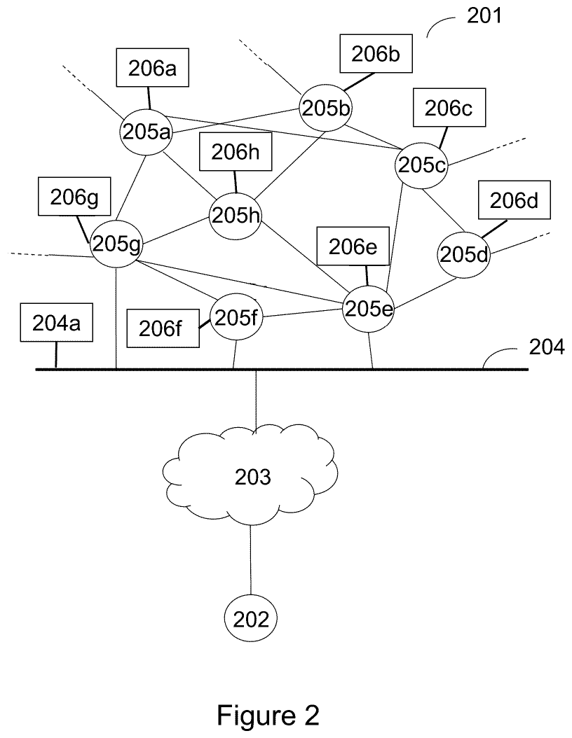

FIG. 2 presents schematically an example network architecture of one embodiment of the invention in which the solution of the invention can be used. In FIG. 2 a part of a first computer network 201 is schematically illustrated into which a computer system, for example an EDR or MDR system, has been installed. Also, any other computer system that is able to implement the embodiments of the invention can be used instead or in addition to the EDR or MDR system used in this example. The first computer network is connected to a security service network, here security backend/server 202 through the cloud 203. The backend/server 2 forms a node on the security service computer network relative to the first computer network. The security service computer network can be managed by an EDR or MDR system provider and may be separated from the cloud 203 by a gateway or other interface (not shown) or other network elements appropriate for the backend 202. The first computer network 1 may also be separated from the cloud 203 by a gateway 204 or other interface. Other network structures are also possible.

The first computer network 201 can be formed of a plurality of interconnected nodes 205a-205h, each representing an element in the computer network 201 such as a computer, smartphone, tablet, laptop, or other piece of network enabled hardware. Each node 205a-205h shown in the computer network also represents an EDR or MDR endpoint onto which a security agent module 206a-206h, that may include a data collector or a sensor, is installed. Security agent modules may also be installed on any other element of the computer network, such as on the gateway or other interface. In the example of FIG. 1 a security agent module 204a has been installed on the gateway 204. The security agent modules, 206a-206h, 204a collect various types of data at the nodes 205a-205h or gateway 204 including, for example, program or file hashes, files stored at the nodes 205a-205h, logs of network traffic, process logs, binaries or files carved from memory (e.g. DLL, EXE, or memory forensics artefacts), and/or logs from monitoring actions executed by programs or scripts running on the nodes 205a-205h or gateway 204 (e.g. TCP dumps).

The data collected e.g. by the sensors and/or the server, may be stored in a database or similar model for information storage for further use. Any kind of threat models may further be constructed at the nodes 205a-205h by a security application, at the backend/server 202, and/or at a second server and be stored in the database. The nodes 205a-205h and the server 202 typically comprise a hard drive, a processor, and RAM.

Any type of data which can assist in detecting and monitoring a security threat, such as a security breach or intrusion into the system, may be collected by the security agent modules 206a-206h, 204a during their lifecycle and that the types of data which are observed and collected may be set according to rules defined by the EDR system provider upon installation of the EDR system and/or when distributing components of a threat detection model and/or a behavior model. In an embodiment of the present invention, at least part of the security agent modules 206a-206h may also have capabilities to make decisions on the types of data observed and collected themselves. For example, the security agents 206a-206h, 204a may collect data about the behavior of applications and/or programs running on an EDR or MDR endpoint and can observe when new programs and/or applications are started. Where suitable resources are available, the collected data may be stored permanently or temporarily by the security agent modules 206a-206h, 204a at their respective nodes or at a suitable storage location on the first computer network 1 (not shown).

The security agent modules 206a-206h, 204a can be set up such that they send information such as the data they have collected or send and receive instructions to/from the EDR or MDR backend 202 through the cloud 203. This allows the EDR or MDR system provider to remotely manage the EDR or MDR system without having to maintain a constant human presence at the organization which administers the first computer network 201.

In one embodiment of the invention, the security agent modules 206a-206h, 204a can also be configured to establish an internal network, e.g. an internal swarm intelligence network, that comprises the security agent modules of the plurality of interconnected nodes 205a-205h of the local computer network 201. As the security agent modules 206a-206h, 204a collect data related to the respective nodes 205a-205h of each security agent module 206a-206h, 204a, they are further configured to share information that is based on the collected data in the established internal network. In one embodiment a swarm intelligence network is comprised of multiple semi-independent security nodes (security agent modules) which are capable of functioning on their own as well. Thus, the numbers of instances in a swarm intelligence network may well vary. There may also be more than one connected swarm intelligence networks in one local computer network, which collaborate with one another.

The security agent modules 206a-206h, 204a can be further configured to use the collected data and information received from the internal network for generating and adapting models related to the respective node 205a-205h and/or its users. Models can be for example user behavior models, threat detection models, models of normal behavior of an application, etc.

In one embodiment of the invention the malware analysis environment, service and/or software can detect starting and closing of applications, all processes related to applications and processes. Also, when the services are started early, the service can be able to detect and follow most of user's applications. In one embodiment of the invention, when the malware detection software or service is started up, it can perform running application inventory.

In the solution of the invention data is collected related to a computer and/or a computer network, the collected data relating at least to behavior of at least one application. A model of normal behavior of the at least one application is built based on the collected data, and this enables the system to learn and know the expected and frequently occurring behaviour or operation for the application. In the solution of the invention, it's also checked whether the application has vulnerabilities, e.g. by requesting and/or receiving vulnerability information relating to the at least one application. In one embodiment of the invention a configuration is built for the application, e.g. application control policy for the application, if the received vulnerability information indicates that the application has a vulnerability.

The built configuration for an application is such that it restricts and/or prevents the operation of the application if a deviation is observed between the monitored behavior of the application and the built normal model of the application. The configuration can be for example a configuration, such as an ApplicationControl configuration, an Applocker configuration, a firewall configuration, that allows already known behaviour but will block any other operation.

The applications can be monitored, e.g. at the host, computer and/or at the backend, by tracking events created by the monitored application, such as created or changed files, accesses to registry, changes done to registry, created processes, created child processes, injection of processes in other processes, and/or by analyzing captured events to be malicious, e.g. by recognizing known patterns of file encryption, preventing malware detection by the application.

In the solution of the invention the applications can be monitored e.g. from MDR or EDR event telemetry event flow, for example either at the sensor of a node or computer or at the backend. In one embodiment of the invention information about normal, i.e. usual and frequent, behaviour and/or operation of the application is collected from multiple hosts or computers of the computer network, such as a threat detection network. A behavioural digest can be built for all applications and services, e.g. that execute for longer time than a predefined duration, on the device. Vulnerability information for an application can be queried and received from a server, a service, a backend system, an external source and/or vulnerability management service, e.g. based on an identifier of the application. In one embodiment the solution of the invention can check in which hosts a certain application is installed. An application control policy can be created for at least part of the hosts or computers of the network or for each computer of the network. The application control policy can be e.g. such that it allows the network connections, file write destinations, and child process executions, other operations that have been previously done on said host by the application, and which e.g. blocks or alerts on every other action by the application. The end result can be a set of configurations that allow the vulnerable application to continue carrying out operations that it has been carrying out previously, but anything novel is restricted or blocked.

In one embodiment of the invention any action of the application which deviates from the created normal model, e.g. is out of scope of normal, is allowed to be carried out (only) in the sandbox or other restricting environment. In one embodiment of the invention an alert is created and/or sent if a deviation from normal behavior of the application can be detected.

In one embodiment of the invention if the application has not previously carried out any certain kind of operation, the operation is always denied if the application is vulnerable. In one embodiment of the invention, if the application has carried out the operation less than a predefined number of times (but more than zero times), e.g. couple of times, for example 1-2 or 1-3 times, the operation is allowed in a restricted environment, such as a sandbox. In one embodiment of the invention, if the application has carried out the operation more than a predefined number of times, e.g. more than 2 times, more than 3 times, more than 4 times, more than 5 times or more than 6 times, the operation of the application is allowed normally.

If a sandbox service is utilized, an application can be uploaded to a backend service, where it will be detonated in a virtual machine. The virtual machine and sandbox service can also be used at the local machine, e.g. a computer, an endpoint or host. The service will monitor the behaviour of the application in the virtual machine, and it can build a risk rating for the application. In one embodiment of the invention, virtualization or emulation, such as hardware virtualization, e.g. Hyper-V, software virtualization or emulation can be utilized. Virtual machine or emulator can execute a virtual copy of operating system on local machine or a server, such as a LAN server. In one embodiment a virtual machine or a software emulator can be started and/or initialized in response to starting a software application at a local machine and/or e.g. when an application carries out on action which is not allowed by the model of normal behavior of the application. The software application can be passed to the virtual machine or the software emulator. Application events and/or behavior is analyzed at the virtual machine or the software emulator to determine malicious behavior of the application. Based on the detected malicious behavior of the software application at the virtual machine or the software emulator, the local machine can be notified about the malicious behavior and the virtual machine.

A sandbox unit which can be utilized in the solution of the invention can in one embodiment of the invention be a group of components that enable tracing of system-wide behaviour of a given application in a contained manner by executing the application with restricted access and/or non-persistent access (changes made by the application may be rolled back). The unit can be responsible for quarantining the application, and when the application was already executed on the computer, also to revert the system changes e.g. based on the created backup. Likewise, the unit can also be responsible for performing the undo on any quarantine operations. If the malware analysis is done at a virtual machine, reverting the device and/or system settings and/or removal of detected malware may not be necessary.

In the following an example embodiment of the invention is presented in more detail. In this example an FTP application is used as an example of the monitored application, but of course same steps can be done to any application running on a computer.

In order to determine running processes of a computer process execution telemetry can be read from an agent of the host or network, e.g. EDR or MDR agent. This can be achieved by connecting to the system's API or database, e.g. MDR/EDR system's API or database. A query can be done for the telemetry data for process execution logs for a computer or network. The received data can be parsed to extract relevant information about the processes.

Processes for a certain application (e.g. an FTP application) can be filtered to identify which processes are related to a certain application (e.g. the FTP application). Then a a list of these processes can be created, e.g. including their paths and any other identifying attributes.

Based on this, a configuration for the application, e.g. an AppLocker profile, can be created by use the list of processes related to a certain application (e.g. the processes related to the FTP application). This can be done e.g. by creating rules of the application configuration, such as AppLocker rules. The rules can be formatted according to the application configuration, e.g. AppLocker's XML schema. The rules can include rules that specify allowable (‘Allow’) actions for the identified processes.

The generated configuration for the application, e.g. an AppLocker profile, can be saved and exported for example to a file, e.g. AppLocker profile as an XML file. Then the created application configuration can be utilized. The configuration/profile can be for example imported into the Group Policy Management Console (GPMC) or local security policy.

The above example steps only list some examples which can be used in the solution of the invention, but also other technologies can be used such as Windows Sandbox, or Microsoft Defender Application Guard, or third-party sandbox software that have a feature for process execution, file write, network destination, etc. allowlisting.

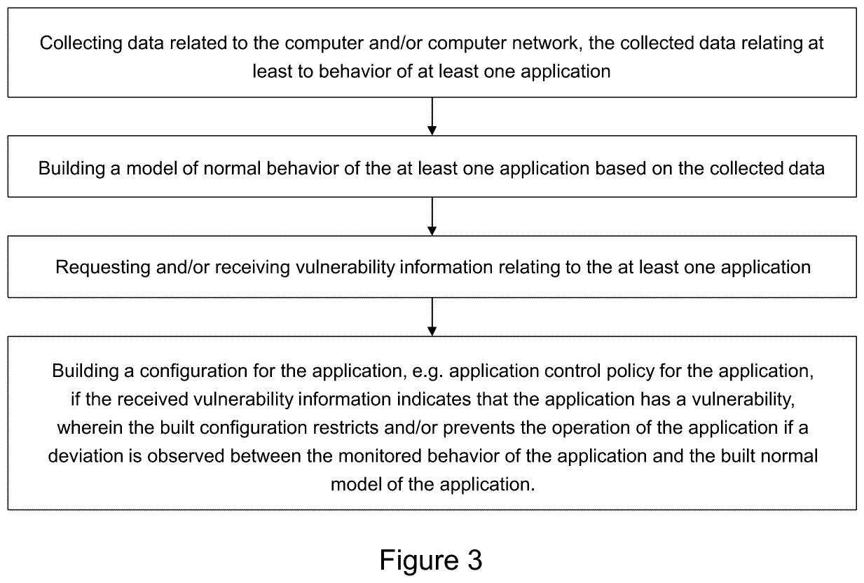

FIG. 3 presents an example method according to one embodiment of the invention. The example method comprises collecting data related to the computer and/or computer network, the collected data relating at least to behavior of at least one application, building a model of normal behavior of the at least one application based on the collected data, requesting and/or receiving vulnerability information relating to the at least one application, building a configuration for the application, e.g. application control policy for the application, if the received vulnerability information indicates that the application has a vulnerability, wherein the built configuration restricts and/or prevents the operation of the application if a deviation is observed between the monitored behavior of the application and the built normal model of the application.

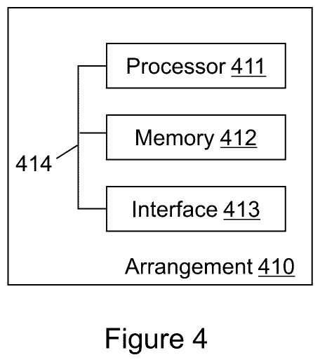

As presented in FIG. 4, an arrangement 410 or at least part of the arrangement, e.g. a computer, an endpoint and/or a server, according to exemplifying embodiments of the present invention may comprise at least one computer which comprises a processor 411 and at least one memory 412 (and possibly also at least one interface 413), which may be operationally connected or coupled, for example by a bus 414 or the like, respectively.

The processor 411 of the arrangement 410 is configured to read and execute computer program code stored in the memory 412. The processor may be represented by a CPU (Central Processing Unit), a MPU (Micro Processor Unit), etc., or a combination thereof. The memory 412 of the arrangement 410 is configured to store computer program code, such as respective programs, computer/processor-executable instructions, macros or applets, etc. or parts of them. Such computer program code, when executed by the processor 411, enables the arrangement 410 to operate in accordance with exemplifying embodiments of the present invention. The memory 412 may be represented by a RAM (Random Access Memory), a ROM (Read Only Memory), a hard disk, a secondary storage device, etc., or a combination of two or more of these. The interface 413 of the arrangement 410 is configured to interface with another arrangement and/or the user of the arrangement 410. That is, the interface 413 may represent a communication interface (including e.g. a modem, an antenna, a transmitter, a receiver, a transceiver, or the like) and/or a user interface (such as a display, touch screen, keyboard, mouse, signal light, loudspeaker, or the like).

The arrangement 410 may, for example, represent a computer 1 or may represent a (part of a) server 2 in FIG. 1. The arrangement 410 may be configured to perform a procedure and/or exhibit a functionality as described in any one of FIGS. 1 to 3.

According to exemplifying embodiments of the present invention, the application to be monitored can be any electronic file, particularly encompassing any electronic file including a runnable/executable part, such as any kind of application file. Insofar, exemplifying embodiments of the present invention are applicable to any such electronic file, including for example a file of an Android Application Package (APK), a Portable Executable (PE), a Microsoft Soft Installer (MSI) or any other format capable of distributing and/or installing application software or middleware on a computer.

The data collected with the solution of the invention may be stored in a database or similar model for information storage for further use.

In an embodiment, further actions may be taken to secure the computer or the computer network if a malicious file, application or activity has been detected. Also actions by changing the settings of the computers or other network nodes can be done. Changing the settings may include, for example, one or more nodes (which may be computers or other devices) being prevented from being switched off in order to preserve information in RAM, a firewall may be switched on at one or more nodes to cut off the attacker immediately, network connectivity of one or more of the network nodes may be slowed down or blocked, suspicious files may be removed or placed into quarantine, logs may be collected from network nodes, sets of command may be executed on network nodes, users of the one or more nodes may be warned that a threat or anomaly has been detected and that their workstation is under investigation, and/or a system update or software patch may be sent from the security backend to the nodes. In one embodiment of the invention one or more of these actions may be initiated automatically.

Next some practical example steps of operation of a threat prevention and/or detection solution according to example embodiments of the invention will be described.

Deployment and distributing of the components of the threat detection or prevention system: In one embodiment of the invention, in which all agents may fundamentally have the same code base and/or ability to adapt to their role by activating different components in their modular architecture and replicate themselves, one would merely need to deploy one initial agent in a customer network with sufficient access rights, which would then discover servers and install copies of itself in the suitable locations and establish the internal communications network, e.g. an internal swarm communications network, as well as the backend update, reporting and communication channel. In addition, authentication and other required issues may need to be considered, and in first incarnations agents may be deployed on individual hosts.

Normal operation: The agents continuously monitor their environment and collect data, learning from what they see and build models, e.g. threat detection models and/or models of normal behavior of an application. These models may be shared across swarm nodes and used for learning, for example of users' behavior on one computer vs. others in the network. Additionally, abstract information may be sent to the backend in a privacy preserving way. The agents utilize the abovementioned learning models to be prepared also for knowing what is normal.

Encountering a known threat: The agents detecting either a known threat or an anomaly indicating a known threat may instantly alert other nodes (such as computers or servers) of the situation, also to prepare for threats that may deactivate them, and call for additional resources if needed (spin up new virtual agents or have them delivered from another host if there is risk of compromise). A known threat can be detected based on the behavior of a computer, a user and/or an application when comparing the detected behavior to the behavior model. If the agent already has the means for response, that action may be taken.

Encountering a novel threat: The agents, due to constantly learning what is normal and in a very granular manner due to their specificity with the data of their own nodes combined with the broader view of possible global, organization or user group level models, are also well equipped to detect novel threats. Their ability to interact with the users may be used to verify the threat, and if the threat is verified, take actions to contain it as well as build a new threat model that can be circulated, to other nodes, computers and/or servers. In some embodiments, the risk of the threat may be determined to be so great that autonomous containment actions may also be taken before awaiting a final decision. The degree of autonomous actions can always be adjusted as needed. The connectivity model also allows for the help of human experts to be called upon if needed.

Backend preparation: Constantly during operation, generated behavior models of the applications, users and/or information on events and/or threats can be abstracted and sent to the backend. This enables a backend “laboratory” to continue experimentation on more effective defense tools in a secure environment as well as provides further correlation and analysis of the data sent from the multitude of individual intelligent agents or sensors. Backend can also share threat detection models to the nodes.

As described above, the nature of the model used by the system (e.g. EDR or MDR) may be, or may incorporate elements, from one or more of the following: a neural network trained using a training data set, exact or heuristic rules (e.g. hardcoded logic), fuzzy logic based modelling, and statistical inference-based modelling. The model may be defined to take into account e.g. particular usage patterns of an application, a program, node, files, processes, connections, and dependencies between processes.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. Lists and groups of examples provided in the description given above are not exhaustive unless otherwise explicitly stated.

1. A computer-implemented method of threat prevention in a computer or computer network, the method comprising:
collecting data related to the computer and/or computer network, the collected data relating at least to behavior of at least one application;
building a normal model of normal behavior of the at least one application based on the collected data;
requesting and/or receiving vulnerability information relating to the at least one application; and
building a configuration for the at least one application in a case in which the received vulnerability information indicates that the application has a vulnerability,
wherein the built configuration restricts and/or prevents operation of the application in a case in which a deviation is observed between monitored behavior of the at least one application and the built normal model of the at least one application.

2. The method according to claim 1, wherein the built configuration restricts the operation of the at least one application by only allowing the behavior of the at least one application corresponding to the built normal model of the normal behavior of the at least one application, and/or restricting and/or preventing any other operation of the at least one application.

3. The method according to claim 1, wherein the built configuration allows network connections, file write destinations, and/or child process executions based on the created model.

4. The method according to claim 1, wherein the built configuration comprises process execution, file write, network destination, firewall, sandbox, ApplicationControl, Applocker, Windows Sandbox, Microsoft Defender and/or Application Guard configurations.

5. The method according to claim 1, further comprising:
generating an alert when behavior of the at least one application that is not allowed based on the built normal model of the normal operation of the at least one application is detected.

6. The method according to claim 1, wherein in a case in which the at least one application attempts to carry out tasks that are not allowed based on the built normal model of the normal operation of the at least one application, the at least one application is allowed to run in a restricting environment, such as a sandbox.

7. The method according to claim 1, wherein the collected data from which the model of normal behavior of the application is built comprises expected and/or frequently occurred monitored behaviour of the application.

8. The method according to claim 1, wherein the data is collected from the computer, computer network and/or a backend system by at least one security agent module that collects data related to the computer and/or computer network.

9. The method according to claim 1, wherein the model of normal behavior is built for applications the computer that run and/or execute at the computer longer than a predefined duration.

10. The method according to claim 1, wherein building the model of normal behavior of the at least one application comprises collecting information relating to usage of the at least one application.

11. The method according to claim 1, wherein the vulnerability information concerning the at least one application is received from a server, a service, a backend system, and/or an external source.

12. An arrangement for threat prevention in a computer or computer network, the arrangement comprising:
at least one computer,
the arrangement is configured to:
collect data related to the computer and/or computer network, the collected data relating at least to behavior of at least one application,
build a normal model of normal behavior of the at least one application based on the collected data,
request and/or receive vulnerability information relating to the at least one application,
build a configuration for the at least one application in a case in which the received vulnerability information indicates that the at least one application has a vulnerability,
wherein the built configuration is configured to restrict and/or prevent operation of the at least one application in a case in which a deviation is observed between monitored behavior of the at least one application and the built normal model of the at least one application.

13. The arrangement according to claim 12, wherein the arrangement is configured to carry out a method of threat prevention in a computer or computer network, the method comprising:
collecting data related to the computer and/or computer network, the collected data relating at least to behavior of at least one application,
building a normal model of normal behavior of the at least one application based on the collected data,
requesting and/or receiving vulnerability information relating to the at least one application, and
building a configuration for the application in a case in which the received vulnerability information indicates that the at least one application has a vulnerability,
wherein the built configuration restricts and/or prevents operation of the at least one application in a case in which a deviation is observed between monitored behavior of the at least one application and the built normal model of the at least one application, and
wherein the built configuration restricts the operation of the at least one application by only allowing the behavior of the application corresponding to the build built normal model of the normal behavior of the application, and/or restricting and/or preventing any other operation of the at least one application.

14. A non-transitory computer-readable medium on which is stored a computer program comprising instructions which, when executed by a computer, cause the computer to carry out the method according to claim 1.

15. (canceled)

16. The method of claim 1, wherein the configuration for the at least one application comprises an application control policy for the at least one application.

17. The method of claim 3, wherein actions that are similar to actions that have already been executed on the computer are allowed.

18. The method of claim 8, wherein the security agent module is a module of an EDR and/or MDR system, and/or wherein the data is collected at least in part from event telemetry flow.

19. The method of claim 10, wherein the information relating to usage of the at least one application comprises frequency of operations and/or types of operations related to the application.
